(19) United States
(12) Patent Application Publication
(10) Pub. No.: US 2025/0332911 A1
(43) Pub. Date: Oct. 30, 2025

(54) DUAL VALVE SYSTEM FOR A FUEL TANK

(71) Applicant: Walbro LLC, Cleveland, OH (US)

(72) Inventors: Richard J. Salcido, Cleveland, OH (US); Gary J. Burns, Willington, MI (US)

(73) Assignee: Walbro LLC, Cleveland, OH (US)

(21) Appl. No.: 19/188,346

(22) Filed: Apr. 24, 2025

Related U.S. Application Data
(60) Provisional application No. 63/638,395, filed on Apr. 24, 2024.

(51) Int. Cl. B60K 15/077; B60K 15/03; B60K 15/035

(52) U.S. Cl. CPC B60K 15/077; B60K 15/03519; B60K 2015/03296; B60K 2015/03388; B60K 2015/03401

(57) ABSTRACT

A fuel tank assembly having a fuel tank and a first valve assembly in fluid communication with the fuel tank configured to selectively allow air to pass through an outlet vent when the vehicle is in an operational orientation, and to restrict fuel flow from out of the gas tank if the vehicle is not in an operational orientation. The fuel tank assembly also has a second valve assembly in fluid communication with the first valve assembly configured to regulate pressure within the fuel tank by permitting air to enter the fuel tank when internal pressure of the fuel tank falls below a first threshold, and permitting air to exit the fuel tank when internal pressure exceeds a second threshold. The valve assemblies are connected in-line such that air entering or exiting the fuel tank via the outlet vent passes through both the first and second valve assemblies.

### CLAIM OF PRIORITY TO PRIOR APPLICATION

This application claims the benefit of the filing date of U.S. Provisional Application Ser. No. 63/638,395, filed on Apr. 24, 2024, entitled “DUAL CHECK VALVE ASSEMBLY FOR FUEL TANK”. By this reference the entire disclosure, including the claims and drawings, of U.S. Provisional Application Ser. No. 63/638,395 is hereby incorporated into the present disclosure as though now set forth in its entirety.

### TECHNICAL FIELD

The present disclosure relates generally to fuel tank pressure and relief valves. More particularly, in one example, the present disclosure relates to a check valve assembly to regulate pressure in a related fuel tank. Specifically, in another example, the present disclosure relates to a check valve assembly in-line with a roll over valve vent tube for the regulation of pressure in a related fuel tank.

### BACKGROUND

Side-by-side utility vehicles (UTVs) and all-terrain vehicles (ATVs) typically utilize a fuel tank that includes a roll-over valve that will stop fuel from leaking out of the tank in the event of a vehicle roll-over wherein the vehicle and fuel tank would be oriented upside down or sideways. With these vehicles, a roll-over is not an uncommon event, so the fuel system is designed to allow for the vehicle to be reoriented following a roll-over even and still operate normally.

Fuel tanks, particularly those used with smaller vehicles and smaller engines, are prone to static electricity build up, which can have a negative effect on the performance of the engine and other fuel components. One current solution to deal with static electricity build up in the fuel tank of UTVs and ATVs is to maintain an in-tank pressure of approximately 0.5 psi (±0.5). During operation of the UTV/ATV, the tank will experience vibration which will result in an increase in temperature of the tank, thus causing the pressure in the tank to rise. When the vehicle is not in use, the tank and fuel cools, causing the pressure in the tank to decrease. In order to regulate the in-tank pressure, a check valve is commonly employed to maintain the pressure within the desirable range. The check valve may be configured to allow air into the tank when the internal pressure drops below the minimum desired pressure, and to allow air to escape the tank when the pressure exceeds the maximum.

One downside of the use of a check valve to regulate pressure is that the inclusion of the check valve often compromises the performance and function of the roll over valve in that the check valve cannot be configured to prevent fuel leakage in a roll-over event. Thus, if used on a vehicle, such as a UTV or ATV that is prone to roll-over events, the fuel can leak from the check valve and create a hazard, especially upon re-igniting the engine after the vehicle is reoriented.

### SUMMARY

The present disclosure addresses these and other issues by providing a dual check valve for use in conjunction with a roll over fuel valve that allows pressure regulation within a fuel tank without compromising the function and performance of the roll over fuel valve.

In one aspect, an exemplary embodiment of the present disclosure may provide a fuel tank assembly with a dual valve configuration as described herein.

In another aspect, an exemplary embodiment of the present disclosure may provide a method of use for a dual valve system for a fuel tank as described herein.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a side elevation view of an embodiment of a fuel tank assembly with a check valve assembly and roll over valve assembly connected thereto, according to one aspect of the present disclosure.

FIG. 2A (FIG. 2A) is a side view of an embodiment of a roll over valve assembly for use with a fuel tank, according to one aspect of the present disclosure.

FIG. 2B (FIG. 2B) is a cross-sectional view of an embodiment of a roll over valve assembly for use with a fuel tank, according to one aspect of the present disclosure.

FIG. 3 (FIG. 3) is a cross-sectional view of an embodiment of a check valve assembly for use with a fuel tank, according to one aspect of the present disclosure.

FIG. 4 (FIG. 4) is a cross-sectional view of an embodiment of a dual check valve assembly for use with a fuel tank, according to one aspect of the present disclosure.

Similar numbers refer to similar parts throughout the drawings.

### DETAILED DESCRIPTION

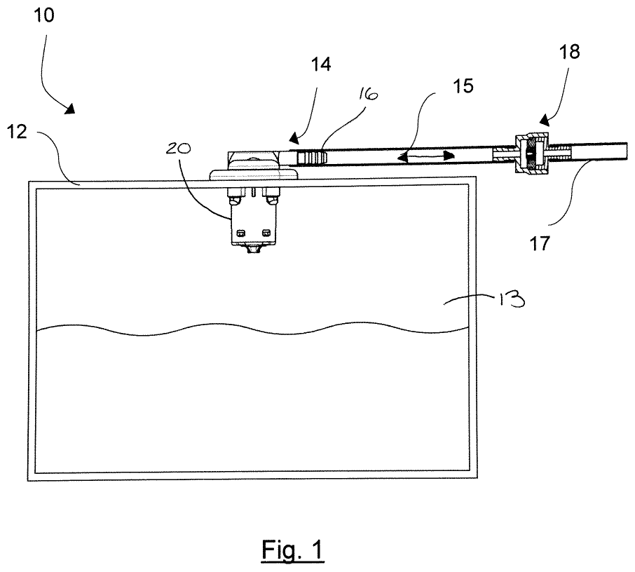

With reference to FIG. 1, a fuel tank assembly 10 is shown. Fuel tank assembly 10 may be considered as the entire assembly, including a fuel tank 12 with a reservoir 13, a roll over valve assembly 14, and a check valve assembly 18. Fuel tank assembly 10 may be, or further include, other standard fuel tank components and elements as dictated by the desired implementation. The fuel tank assembly 10, can include a first inlet/outlet line 15 and a second inlet/outlet line 17. As shown and described herein, fuel tank assembly 10 may be a fuel tank assembly for use with an associated a utility vehicle (UTV), such as a side-by-side UTV or the like, or an all-terrain vehicle (ATV), or other similar vehicles.

Fuel tank 12 may be a standard fuel tank operable to hold or contain liquid fuel therein. According to one aspect, the fuel tank 12 may be molded from a polymer material. According to another aspect, the fuel tank 12 may be formed of any suitable material using any suitable method of manufacture. Fuel tank 12 may generally be configured to fit the associated vehicle, such as a UTV or ATV, and may therefore be of any suitable shape and or size. Fuel tank 12 may be further configured for normal operation in an upright position, and may further include any suitable fuel inlets, outlets, valves, pumps, or the like as needed for normal operation thereof.

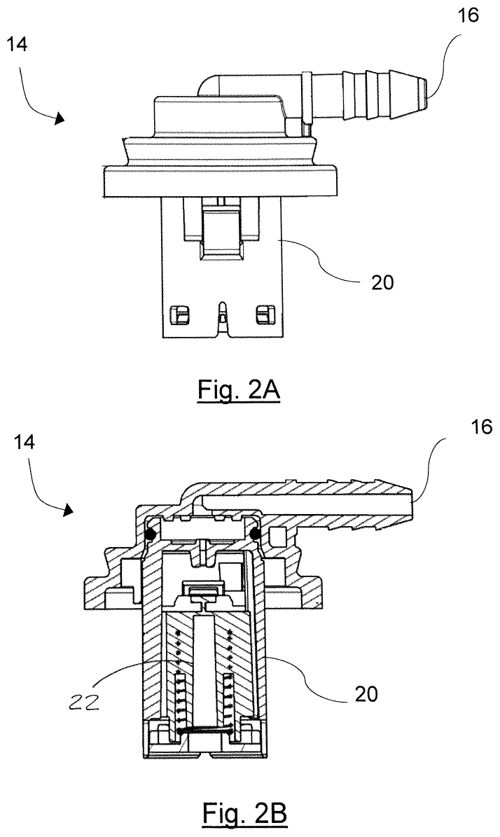

FIGS. 2A & 2B show an exemplary roll over valve assembly 14 that may include a vent 16 and a roll over valve 20. The roll over valve assembly 14 may be configured to be connected to, and in fluid communication with, the fuel tank 12 to allow air/fuel vapors to pass through the roll over valve assembly 14 during normal operation of the associated vehicle, as discussed herein.

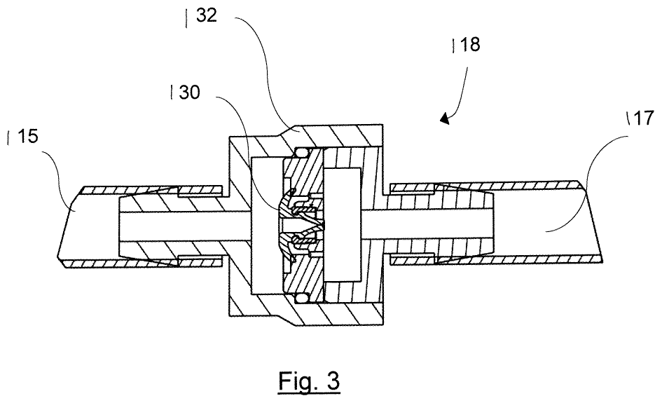

Valve assembly 14 may generally be understood as an opening in the fuel tank that may allow air (and/or fuel vapor) to enter and/or escape from the fuel tank 12. Referring to FIG. 3, an outlet for the vent can be extended through lines 115, 117 or other components such as the dual check valve assembly 118.

In FIGS. 2A & 2B, vent 16 may be configured for compatibility with the specific design of the fuel tank 12 as well as configured to allow movement of air into or out of the fuel tank 12 according to the desired pressure within the tank itself. The inclusion of a vent 16 may be generally to prevent overpressure of the fuel tank 12, and may further be configured to allow for a vacuum within the fuel tank 12 for proper fuel flow rate and delivery to a vehicle engine. As used and understood herein, vent 16 may be configured according to the operating guidelines of the vehicle (as compared to the check valve assembly 18, which may be configured and/or calibrated to address the buildup of static electricity, as discussed further below).

Roll over valve 20 may be any suitable roll over valve type configured to allow air to pass therethrough when an associated vehicle is running in an upright and normal position. As used herein, upright and normal position will be understood to be a position wherein the associated vehicle is in its normal operating position. For a normal side-by-side UTV, for example, the upright and normal position would be with all four wheels of the UTV in contact with a ground surface. Roll over valve 20 may be integrated with, or in direct connection with vent 16 such that air passing through roll over valve 20 may be considered to simultaneously pass through the vent 16, and vice versa.

When the associated vehicle is under normal operation, roll over valve 20 may have an internal valve body 22 that may be in an open position allowing air to pass therethrough and on to the engine of the associated vehicle. This valve body may be configured to allow air to pass therethrough when the vehicle is oriented within a desired range of the normal and upright position to allow operation of the vehicle on an incline or on uneven terrain. In a roll over event, i.e., an event wherein the vehicle tilts or is otherwise oriented at an angle that exceeds the desired range such that a wheel of the UTV is not contact with a ground surface, the roll over valve 20 may close automatically, thus cutting off any flow of fuel out of the gas tank 12 through the roll over valve 20 and vent 16. Most commonly, roll over valve 20 may employ a ball and/or a float that is disengaged from a vent opening within roll over valve 20 during normal operation. That is, when the orientation of the vehicle exceeds normal operational limits, gravity may cause the ball to engage and block the vent opening. Where the roll over valve 20 utilizes a float, the flow of fuel through the roll over valve 20 body may likewise cause the float to move into a position to block the vent opening. In any common roll over valve type (ball, float, or a combination thereof), the physical orientation of the vehicle may dictate whether or not the vent opening is obstructed.

As discussed above, one issue that exists with fuel tank assemblies in general is the buildup of static electricity in the tank as both the fuel tank and fuel therein, when subjected to varying temperatures, can expand and contract. These varying temperatures may be caused by the external environment but may also occur as a result of normal operation of the associated vehicle. For example, as the associated vehicle is operated, the burning of the fuel may cause the temperature of the fuel system to increase. Similarly, vibrations caused by the operation of the vehicle may likewise increase the temperature of the fuel system. As the temperature increases, the fuel and fuel tank tend to expand, thus increasing the pressure in the system. Along with an increase in pressure, this expansion is known to cause a buildup of static electricity in the fuel tank itself. Once the vehicle is turned off, the temperatures decrease, and the fuel system contracts, but the static electricity may remain in the system. Over time, this can cause a hazard as an excess of static electricity build up can lead to a fire or explosion risk.

As further discussed above, maintaining the pressure within the fuel tank of a vehicle within a range of approximately 0-1 psi may prevent the buildup of static electricity within the tank and may further reduce or eliminate a static discharge. According to one aspect, a pressure within the tank of approximately 0.5 psi allows for normal operation of the fuel system while simultaneously creating an internal environment that reduces the chances for a static discharge. According to another aspect, maintaining the pressure at approximately 0.5±0.5 psi likewise allows for normal operation with a reduced chance of a static discharge.

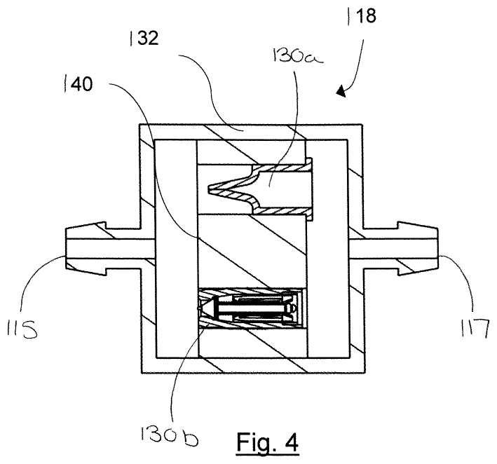

With reference to FIGS. 1, 3, & 4, to regulate the pressure within the fuel tank 12 (as seen in FIG. 1), a check valve assembly 118 may be provided. Check valve assembly 118 may include any suitable check valve arrangement, including, but not limited to, a single valve 130 (as seen in FIG. 3), dual valves 130a, 130b (as seen in FIG. 4), or the like. That is, the check valve assembly 118, whether in single valve 130, or dual valve 130a, 130b configuration can be deployed in the same location as check valve assembly 18 as shown in FIG. 1.

The check valve assembly 118 may include valves 130, 130a, 130b of any suitable type, such as inlet duckbill valves, stiff duckbill valves, spring loaded valves, umbrella valves or the like, or any suitable combination thereof. Referring to FIGS. 3 and 4, check valve assembly 118 may further include a casing 132 and a first inlet/outlet line 115 between the check valve assembly 118 and the roll over valve assembly 14. The check valve assembly 118 could also include a second inlet/outlet line 117 which may be substantially identical to the first line 115 but for their placement relative to the check valve assembly 118. Both first and second inlet/outlet lines 115, 117 may function to allow air to move therethrough in either direction, as discussed below.

Check valve assembly 118 may be calibrated to allow air to move into and out of the fuel tank 12 according to the pressure within the tank 12. Specifically, according to the aspects described herein, check valve assembly 118 may be calibrated to allow air into the tank when the pressure therein drops below 0.5 psi. Similarly, the check valve assembly 118 may allow air to escape the fuel tank 12 when the pressure therein exceeds 0.5 psi. According to another aspect, check valve assembly 118 may allow air to enter the tank 12 when pressure drops below 0 psi, and air to escape when pressure exceeds 1 psi.

Referring back to FIG. 1, current fuel tank assemblies may employ a check valve assembly 18 as part of the fuel system. However, in the current art, the inclusion of the check valve assembly 18 is presently accomplished using a separate opening in the fuel tank 12. This allows for the normal venting provided by vent 16 and roll over valve 20, while also allowing for the pressure regulation provided by the check valve 18.

However, the inclusion of both valves defeats the purpose of both valves. Specifically, including a separate check valve assembly 18 in a fuel tank assembly 10 utilizing a separate opening renders the roll over valve 20 inoperable, as in the event of a roll over, the roll over valve 20 will close off the vent 16, but fuel could still leak from the check valve 18. Similarly, if the vent 16 and roll over valve 20 allow air into and out of the tank 12, the check valve assembly 18 may be defeated in its function to regulate pressure within the tank effectively.

Accordingly, it is found that keeping the check valve assembly 18 in line with the vent 16 of the roll over valve 20 allows for proper operation of both valves, while further allowing the tank 12 to be properly vented and the pressure to be regulated to prevent static electricity build up. Thus, as seen in FIG. 1, the first inlet/outlet 15 of the check valve assembly 18 is in fluid communication with vent 16 and the roll over valve 20 such that air moving into and out of the fuel tank 12 through vent 16 passes through both the check valve assembly 18 and the roll over valve 20. This configuration maintains the function and performance of the roll over valve 20 in the event of a roll over, while simultaneously allowing the check valve assembly 18 to maintain and regulate the pressure within the tank 12 in the desired range to prevent static electricity.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A fuel tank assembly for a vehicle, comprising:
a fuel tank having a reservoir;
a first valve assembly in fluid communication with the reservoir configured to selectively allow air to pass through a combination inlet/outlet vent when the vehicle is in an operational orientation and to restrict fuel flow from out of the gas tank if the vehicle is not in an operational orientation; and
a second valve assembly in fluid communication with the inlet/outlet vent configured to regulate pressure within the fuel tank by permitting air to enter the reservoir via the inlet/outlet vent when internal pressure of the fuel tank falls below a first threshold, and permitting air to exit the fuel tank via the inlet/outlet vent when internal pressure exceeds a second threshold,
wherein the first and second valve assemblies are fluidly connected in-line such that air entering or exiting the fuel tank via the inlet/outlet vent passes through both the first and second valve assemblies.

2. The fuel tank assembly of claim 1, wherein the first valve assembly is a roll over valve which includes a float or a ball valve configured to obstruct the vent when the orientation of the vehicle exceeds a predetermined range from upright.

3. The fuel tank assembly of claim 1, wherein second valve assembly maintains pressure within the fuel tank in a range of approximately 0.5±0.5 psi.

4. The fuel tank assembly of claim 1, wherein the second valve assembly is a check valve assembly in a dual valve configuration.

5. The fuel tank assembly of claim 1, wherein the second valve assembly is a check valve assembly in a single valve configuration.

6. The fuel tank assembly of claim 1, wherein the second valve assembly is calibrated to allow air to enter the fuel tank when internal pressure is less than approximately 0 psi and to allow air to exit the fuel tank when internal pressure exceeds approximately 1 psi.

7. The fuel tank assembly of claim 1, wherein the second valve assembly comprises a casing and at least a first inlet/outlet line connecting the check valve assembly to the first valve assembly.

8. A method for maintaining internal pressure within a fuel tank of a vehicle, the method comprising:
providing a fuel tank;
directing air flow into and out of the fuel tank through a first valve assembly, the first valve assembly allowing air to pass through an outlet vent when the vehicle is in an operational orientation and to restrict fuel flow from out of the gas tank if the vehicle is not in an operational orientation;
positioning a second valve assembly in fluid communication with the first valve assembly, such that air flowing into or out of the tank passes through both the first and second valve assemblies;
regulating the pressure inside the fuel tank by permitting air to enter the tank when internal pressure falls below a first pressure threshold and permitting air or vapor to exit when pressure exceeds a second pressure threshold; and
maintaining the internal pressure within a range that prevents the buildup of static electricity in the fuel tank.

9. The method of claim 8, wherein the first valve assembly is a roll over valve which includes a float or a ball valve configured to obstruct the vent when the orientation of the vehicle exceeds a predetermined range from upright.

10. The method of claim 8, wherein second valve assembly maintains pressure within the fuel tank in a range of approximately 0.5±0.5 psi.

11. The method of claim 8, wherein the second valve assembly is a check valve assembly in a dual valve configuration.

12. The method of claim 8, wherein the second valve assembly is a check valve assembly in a single valve configuration.

13. The method of claim 8, wherein the second valve assembly comprises a casing and at least a first inlet/outlet line connecting the check valve assembly to the first valve assembly.

14. A fuel tank assembly for a vehicle, comprising:
a fuel tank;
a first valve assembly operable to selectively permit or restrict fluid flow from the fuel tank based on vehicle orientation; and
a second valve assembly configured to regulate gas pressure within the fuel tank by allowing gas to enter or exit the fuel tank based on the gas pressure,
wherein the first valve assembly and the second valve assembly are connected such that the fuel tank is vented through both valve assemblies in series, and the first valve assembly and the second valve assembly are coordinated through a shared flow line to maintain pressure control while preventing fuel escape during a rollover event.

15. The fuel tank assembly of claim 14, wherein second valve assembly maintains pressure within the fuel tank in a range of approximately 0.5±0.5 psi.
